(19) United States
(12) Patent Application Publication
(10) Pub. No.: US 2004/0221231 A1
(43) Pub. Date: Nov. 4, 2004

(54) Editing a document within web-based production system

(76) Inventors: Robert John Madril JR., Boise, ID (US); Shell Sterling Simpson, Boise, ID (US)

Correspondence Address: HEWLETT-PACKARD DEVELOPMENT COMPANY, Intellectual Property Administration, P. O. Box 272400, Fort Collins, CO, 80527-2400, US

(21) Appl. No.: 10/427,062

(22) Filed: Apr. 30, 2003

(51) Int. Cl. G06F 15/00

(52) U.S. Cl. 715/527; 715/530

(57) ABSTRACT

Method and apparatus for generating a return reference from a production system preview page to redirect an edit page back to the production system without sacrificing already entered printing parameters.

### TECHNICAL FIELD OF THE INVENTION

The present invention relates generally to editing documents within a web-based production system.

### BACKGROUND OF THE INVENTION

Desktop applications for computers take on a myriad of functions. Specialized programs are used to generate documents, play games, fill out checks, assist in publishing newsletters and brochures, and the like. Many desktop applications are used to generate materials that are to be printed, for example using any of a variety of printers. Many desktop applications support an integrated preview mechanism. Such a mechanism allows a user to view a representation of what the program believes the document being previewed will look like when the document is printed on a printer. Desktop application preview mechanisms provide a fairly seamless preview cycle, and allow the user to click a button or move to a different view for editing the document should the desire to edit arise during the preview procedure.

However, desktop applications such as those described, with integrated preview mechanisms, do not provide a true preview of what the actual printed page will look like. Instead, such applications provide their previews within the context of the application itself. Therefore, certain parameters are unknown to the application. These parameters include, by way of example only and not by way of limitation, actual paper size on which the document is to be printed, the paper type, advanced features of the printer on which the document will be printed such as n-up, booklet printing capabilities, stapling abilities, duplex printing abilities, and the like. The application uses only the knowledge of the document, and makes various assumptions about any remaining parameters without truly knowing how those parameters will apply to the final printed product. The print preview of such applications is provided within the desktop application, not within the production system directly.

Further, with the continued advances in computer technology, and with the ever-increasing availability and utility of global networks such as the World Wide Web, providers of Internet type services have begun to branch out into offering services that were not previously viable. Such services include a provision of applications over the Internet (typically by entities known as application service providers or ASPs), web based E-mail applications, web based imaging, and the like.

Further, once a document is fully ready for printing, and has been presented to the production system of the particular printer, it is difficult to “go back” to edit the document without closing out of the print application, finding the part of the document to be edited, editing, and re-presenting to the production system. Because of the large number of application specific formatting issues in most applications, it is not feasible for a printer to edit documents.

There is a need in the art for improved editing capabilities, especially in an Internet or web based application field.

### SUMMARY

For one embodiment, a method of editing a document from within a production system includes activating an existing edit hyperlink to access an editable document, generating a return uniform resource locator (URL) to redirect a browser back to the production system, and conveying the return URL to the editable document web page (or logic used to generate a web page). Once the user's browser is viewing the page providing document editing capabilities, a done button containing the return URL is displayed on that page. Once the document is edited, the done button is activated and the user's browser is returned to the production system at the location identified in the return URL. This paragraph of the Summary is more limiting than the broadest claim.

For another embodiment, a method of editing a document from a production system includes activating an existing link to an editable page representing the document, coding a return uniform resource locator (URL) to the production system, and sending the coded return URL to the editable page. A return hyperlink is created on the editable page containing the coded return URL. The page is edited, and the user's browser is redirected to the return URL when editing is complete.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention;

FIG. 3 is a flow chart diagram of a method according to yet another embodiment of the present invention; and

FIG. 4 is a block diagram of a web application on which embodiments of the present invention are practiced.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

One embodiment of the present invention is directed to making a trip from a preview document in a production system, to an editing web page separate from the production system, and back to the production system to re-preview the document after modification, with a minimum of effort for the user to restore the originally desired production options entered before editing. The user is provided a seamless back and forth experience between actual production system previewing and full editing capabilities at the click of a few buttons. The user is able to move between an edit web site and a production system preview web site retaining the current states of both the web sites and the document. In other words, a user at a production system preview web page can enter a number of production options that are controlled and configured by the production system, find an error to edit, click on the edit hyperlink button to have the user's browser directed to a separate edit page external to the production system, edit the document, and return to the production system to view the edited document with the user production system options remaining intact.

The production website in one embodiment contains an edit hyperlink or button which when clicked, redirects the user's browser to another website where the document at issue can be edited. The generation of the edit hyperlink is more fully described in commonly assigned, U.S. patent application entitled PRINT PREVIEW WITH EDIT HYPERLINK (Atty. Docket No. 10019464), which is hereby incorporated by reference in its entirety.

The embodiments of the present invention provide a return hyperlink or button containing a hypertext markup language (HTML) reference (i.e. a hyperlink) to a specific location specified by a uniform resource locator (URL), or the information sufficient for generating such a return reference, or return URL, on the edit page to which the user's browser is directed by activation of the link on the production system page. Once the user finishes editing the document, the user activates the return hyperlink, and the user's browser is directed back to the production system while still maintaining user preferences from the original production website.

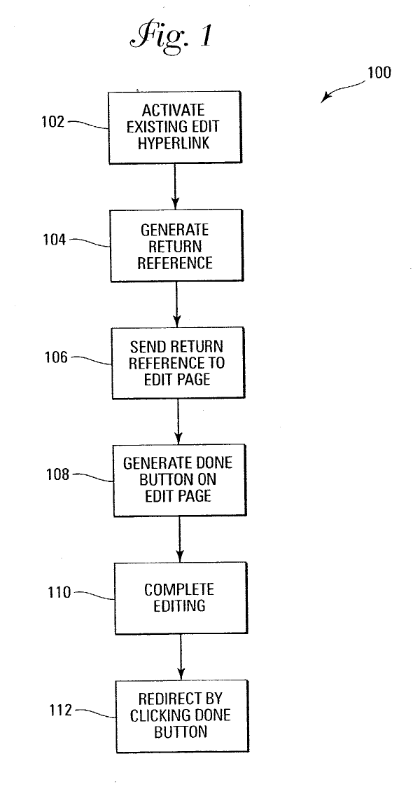

For one embodiment FIG. 1 illustrates, to accomplish maintenance of user preferences, the edit hyperlink on the production website preview web page is activated, that is, the user clicks on the hyperlink causing the user's web browser or user agent to request and display data, usually an html document, from the web server or other server (specified by the reference portion of the hyperlink) by the user in block 102. The production website generates a return URL in a number of ways.

One way to generate a return URL is embedding the return reference in the web page, as it was originally generated. Another way to generate a return URL is linking to a reference back to the production website when the user clicks on the hyperlink on the webpage (block 102). When the browser makes an http request, the web server uses logic that dynamically generates an http “redirect” response. Normal http responses deliver data, which the web browser normally displays to the user. An http “redirect” response tells the browser to request and display data that is at a location specified in the “redirect” response. This location is represented by a URL that is generated during the operation, and can contain the URL parameters.

A third way to generate a return URL is to have Javascript running in the browser (which is embedded into the production website preview web page), which then allows creation of the URL substantially immediately, for example a return uniform resource locator (URL) in block 104 for redirection of the user's browser back to the production system preview web page, and includes the generated return URL with the information sent to the edit page in block 106. This information is normally the URL referencing the edit page. The URL can contain “parameters”. A typical URL consists of a protocol, a machine, a path, a document, and parameters. For example, protocol://machine.com/path/document?name1=value1&name2=value2. The information sent to the edit page is coded to allow the user to return to the production website once editing is complete. This return URL information is used by the software running as part of or in conjunction with the web server that generates the edit page to synthesize a hyperlink or button on the edit page with the return URL as the hyperlink reference to generate a done button or hyperlink on the edit web page in block 108. The done hyperlink on the edit page contains the generated return URL, and when activated after editing is completed in block 110, causes the user's browser to be redirected back to the return URL in block 112.

In one embodiment, the editing system (separate in this embodiment from the production system) opens the original document, and permanently modifies it when editing occurs. The production system, after redirection of the user's browser back to the production system via the return hyperlink, accesses the modified document, and previews the modified version of the document from within the production system. The modified version is accessible through a second return URL provided to the production system, as appended to the return hyperlink. Production is then performed in full on the modified document. By using versioning as described above, every edit or change in one embodiment is stored for later review or retrieval. This provides an undo feature limited only by disk or storage space.

In another embodiment, the editing system adds or otherwise appends, to the return URL provided by the production system web site, a reference to a modified version of the document which is distinct from the original document. The original document is maintained, and a revised version of the document is created. This reference to the modified document is added as an additional parameter in one embodiment to the original return URL that is provided by the production system. When the user's browser is directed back to the production system, the production system accesses the indicated document, as specified by the reference added to the URL rather than the original document. The editing system is responsible for making any modifications that are necessary to enable the production system to access the modified version of the document. Generally, this involves making the modified document honor credentials associated with the original document, with respect to the production service in question.

In yet another embodiment, multiple versions of the document, with various edits having been performed, have their locations encoded into the return URL activated, as described above, from the editable document page to return the user's browser to the production system, and the user is given the option of re-previewing any or all of the versions of the document. This is in one embodiment accomplished through the provision of multiple link buttons each containing a link to one of the various modified documents. The user can then choose which of the versions of the document are previewed. In another embodiment, the last two versions are previewed when the user is redirected back to the production system web site.

When a user's browser is directed to or the user invokes a production system to set up a document to print, there are a number of settings that the production system allows to be set. By way of example only, and not by way of limitation, those settings include the paper type, advanced features of the printer, duplex printing, staple preference, two sided printing, and the like. These preferences are typically set by the user through the production system when the user is preparing to print a document. Often, at some point in the preparation for printing, the user wishes to preview what the printed document will look like. When the user previews the document, which is accomplished through a feature common to most production systems, errors may be found. However, the user has already entered or selected a number or even all of the printing preferences for the document. Leaving the production system for editing has in the past caused all of the user preferences entered for the particular document to be lost. This necessitates remembering or recreating the settings for the document once the editing of the document has been completed and the user is back in the production system.

In another embodiment, the production configuration at the time the user clicks on the edit hyperlink or button on the production system preview page is encoded into the return URL provided to the document editing system web page. This information is then used on the return side after editing when the user's browser is redirected back to the production website using the return URL, to restore the production state to the point when the user activated the edit hyperlink or button. All configuration information and user selected printing preferences for the production system are therefore maintained, such as paper type and size, stapling, duplex, n-up options, and the like, without requiring a total reprovisioning of the configuration parameters. The user preferences that are entered already at the time the edit hyperlink is activated are preserved in the return URL, so that when the user's browser is redirected to the production system after editing, the parameters are re-associated with the newly edited document without the user having to enter the preferences again.

In order to be able to return to the production system with printing parameters intact, in this embodiment a reference containing a return URL is generated, as described above, with respect to the http redirect and Javascript options, by the production system before the user's browser is directed to the edit page. Then, when the document edit link is activated, the production system records a predetermined set of information into the return URL which is sent with the redirected page to the edit page site. The return URL includes sufficient information to allow the user to click on the return link after editing the document, and be returned to the production system with previously selected production preferences intact.

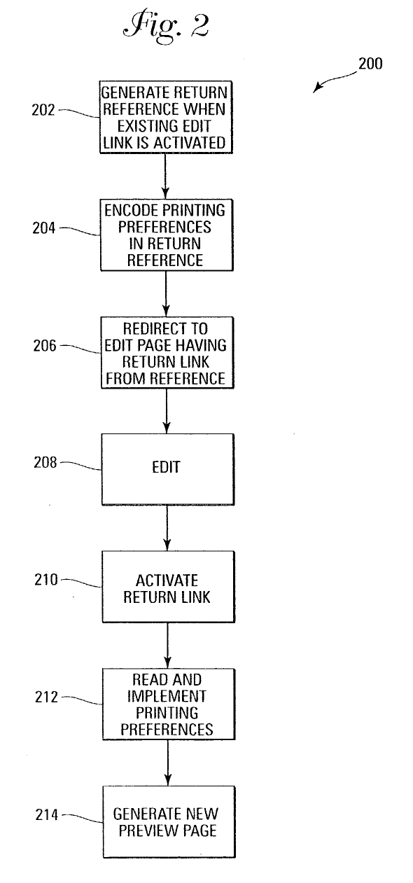

For an example of this embodiment, a method 200 of editing a document is shown in FIG. 2, and comprises generating a return reference when a user in a production system preview context activates an existing edit link in block 202, encoding current printing preferences for the document into a return reference that contains not only the return reference location such as that represented by URL for the preview page, but also the existing printing parameters that the user has already set at the production system in block 204, and directing the user to an edit page with a return reference hyperlink or button that directs the browser back to the production system when editing is complete in block 206. The editable version of the document is in one embodiment generated not by the production system, but instead by either a third party document editor accessible through a web link, or by the program in which the original document was generated, either on a web site or at a known linkable location. The link in one embodiment is a clickable button containing a hypertext markup language (HTML) reference to a specific uniform resource locator (URL) that contains the document to be edited.

When the link is clicked, or activated, the user's browser is redirected to another location, in the existing browser window or a new browser window, at the address supplied in the link in block 206. In one embodiment, this is an edit page generated by a web application. A web application is an application that exposes its user interface through a web browser, for example a web site providing application-like capabilities (e.g. email). The user's browser is redirected to the edit page from the production system. The production system does not need to know any of the particulars of the document that is to be edited, nor does the production system need to know anything about the program which is used to edit the document. All the production system needs is the link to which the user's browser is directed when the URL button or hyperlink is activated. In one embodiment, this hyperlink is supplied with the document when the document is sent to the production system. The production system needs only to place the link in a location accessible to the user so that the user's browser can be directed to the edit page from the production system. In one embodiment, an “edit” button is placed on the preview page so that the user can click through to the edit page directly from the preview page.

Once the browser is at the edit page, the user performs any edits that are necessary or desired in block 208. At this point, the user clicks the return button or hyperlink, and the browser is returned to the production system in block 210. Upon return to the production system, the printing parameters saved with the return hyperlink which is used to redirect the user's browser back to the production system are read and implemented in block 212, and a new preview page is generated in block 214.

When the edit page redirects the user's browser back to the preview page from the edit page, another edit URL may be generated and appended to the return information so that if further errors are found in the resulting preview page, the user can once again edit the document.

When the user wishes to edit a document that is already at the production system, the user clicks the hyperlink or button, already described above, that redirects the user's browser to another web site for editing the document. In this embodiment, when the user clicks the hyperlink, the process creates a return hyperlink to the production system, including in the coding of that hyperlink the specific preferences or parameters that the user has already entered for the document at the production system. The user edits the document external to the production system. When the editing is complete and the user wishes to return to the production system, the user clicks the return hyperlink. This hyperlink redirects the user's browser to the production system at the point where the user left the production system, with chosen settings and parameters still in place and the document ready to be viewed or produced with the same parameters that were in effect when the user clicked the edit link.

The production system and the edit page may also use identity services such as those anticipated for use on the Internet today. The identity services store identities that contain personal information about a user, such as airline preferences, book purchase preferences, and the like. One embodiment retrieves a user identity or identities relating to printing and document access to create the links described above. For example, suppose a user has a number of identities. Identities for the purposes of this application are services that represent a user, including other entities, web services, or even devices that can be accessed to gain information about the user and supply information that is relative to the particular user, such as preferred seating arrangements on airplanes, preferred car rental type, and the like. An identity service is a web service that provides access to information, such as that contained in a specific user identity, associated to a specific user.

Examples of such services are known under names such as wallet, itinerary, travel, car rental, and the like. For example, a wallet identity stores information about a user including name, address, credit card information, and the like, and can be used to make payment without entering a large amount of information, because the information is already present in the wallet identity.

Identity information can be used to retrieve information associated with the user (identity information) related to printing and document access. For example, identity information includes active document and selected document, preferred printing, printer preferences, and the like. Identity information is stored in identity services which make the identity information accessible to other parties. Each of the identity services stores information pertinent to a specific identity, which is typically an end-user. The selected document identity service contains information relating to the currently selected document, such as a reference to that document, in one embodiment the document to be previewed with the production system. The preferred printing identity service contains information relating to a printer bank, a specific printer, a web location of a print or production system service, or the like, that is identified with the particular user. The preferred printing identity service contains a reference (i.e. a URL) to the web site where the user prefers to browse after making a print request. The identity services are used in conjunction with the web applications to provide information about documents and production systems without requiring extensive contemporaneous data entries by the user. The identity service is completely independent of the production service or the editing service. It exists to provide controlled access to information about the user. An identity service does not contain the specific preference that a user selected for the current production activity, although it might contain the user's “default” preferences.

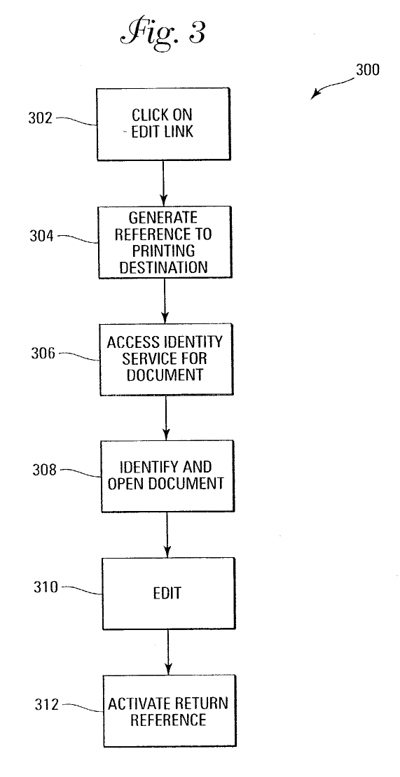

An embodiment 300 of a method using identities and identity services to accomplish editing and return to a preview page is shown in FIG. 3. For method 300, a hyperlink to an edit page has already been generated and placed on the preview page of a production system. The hyperlink may be a link to a selected document identity that contains information about the document the user has sent to the production system. When the user wishes to edit the page, the user clicks on the edit hyperlink in block 302. The reference to a printing destination is generated in block 304, using information from an identity service for the user that identifies the user's preferred printing destination.

The production system also accesses an identity service in block 306 that contains information about the currently previewed document, for example a selected document identity service that the user had used to generate the original hyperlink to the edit page. In the production system, the preferred printing destination and selected document identity services are accessed to obtain the information related to the document to be edited. Once the information about the document is known, the production system either links to the document, or retrieves the actual document for editing in block 308. The user edits the document in block 310. When the user is ready to return to the preview page, the user clicks the return reference link and the user's browser is redirected in block 312 to the preferred printing destination identified by the identity service for the user's preferred printing destination.

A return message can be generated to be sent from the web application edit page to the production system. The return message contains a return reference such as a return URL having encoded in it information concerning the user printing parameters that had been selected prior to editing. Alternatively, the return URL could access a printing preferences identity service for the user that contains the typical or custom printing parameters the user desires. Also, the user could select one of a number of predefined printing parameter solutions depending upon the type or style of the document to be edited, and the return reference could redirect the user's browser to a printing destination identified in a desired printing preference identity service after editing is completed on the document. The production system may contain a production system parameter bank that has information on the printing parameters and their settings for the production system.

The URL generated or retrieved by the production system may be for a web service (i.e. a web service providing access to the production system, the document, or the like). A web service is a network service that is implemented using for example simple object access protocol (SOAP). SOAP is a lightweight remote procedure call protocol designed to be used in a decentralized, distributed environment. It is an extensible markup language (XML) based protocol that consists of three parts, an envelope that defines a framework for describing what is in a message and how to process it, a set of encoding rules for expressing instances of application-defined datatypes, and a convention for representing remote procedure calls and responses. Web services need not be accessed by SOAP. Alternatively, web services are services that are programmatically accessed through a remote procedure call mechanism based on web standards such as xml, http, and SOAP.

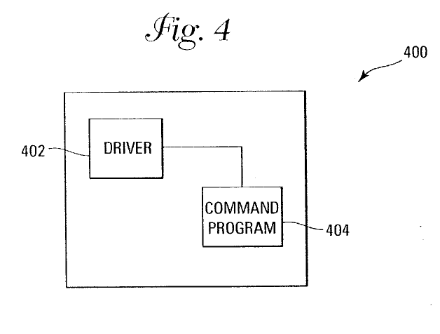

A computer program representing a web application that represents a printing system 400 comprises in one embodiment a production system driver 402 and a command program 404 for operating the production system driver, as is shown in FIG. 4. The command program is a set of machine readable instructions that cause the web application to execute the methods described above. For example, a web application is initiated or activated by a command call from another web application, a computer, a production system, or the like. The command call is an instruction to the web application to perform a series of instructions or a method within the called web application.

Upon initiation of a call to the web application representing a print system 400, the command program 404 is activated. The command program obtains the URL at which the document to be produced is located, through one of the methods described above. Once the command program has the URL, the command program 404 places an edit button on a preview page for the document. The edit button may be, for example, a hyperlink to the URL at which the document is located. When the user desires to edit the document being previewed, the user clicks the edit button and the user's browser is redirected to the edit page. The print driver may operate in a web application, on a printing system, or on a computer, and is accessed in standard fashion.

The methods shown in the Figures may be implemented in whole or in part in various embodiments in a machine readable medium comprising machine readable instructions for causing a computer or a web application to perform the methods. The computer programs run in a computer on a central processing unit out of main memory, and may be transferred to main memory from permanent storage via disk drive or CD-ROM drive when stored on removable media or via a network connection or modem connection when stored outside of the computer, or via other types of computer or machine readable media from which it can be read and utilized. The computer programs run, as sub-modules of a web application, when running in that context.

Such machine readable media may include software modules and computer programs. The computer programs may comprise multiple modules or objects to perform the methods in the Figures or the functions of various apparatuses of the Figures. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### Conclusion

Methods and apparatus for providing editing and return to a production system have been described herein. A return hyperlink to a preview page is generated when a user clicks an existing edit hyperlink. The various user selected parameters for printing are in one embodiment encoded into the return URL so the user does not have to re-enter the parameters upon returning to the production system after editing. In other embodiments, identity services are used to identify and direct the user's browser to one or more identity services for accessing selected documents, preferred printing destinations, and printing parameters.

Methods and apparatus for supplying a return key (or URL) with production system parameter settings to allow the user to click back from an editing page that is provided through the application have been described. Using the methods and apparatus, the production system does not need to know anything about any document editing, so that the user when finished editing is directed back to the production system with appropriate already chosen options intact. Such options include for example the printing parameters such as duplex, booklet, stapling, paper type and size, and the like.

The various embodiments of the invention provide methods and apparatus for providing a return link from an edit page that has been linked from a production system such as a printer or the like. The existing link is on a preview page within the production system, and is an externally generated link to an external web page not controlled by the production system. The production system needs to know nothing about the edit page except how to supply information for generating a return link to the preview page. Therefore, all that is necessary for the linking back from the external web page is a uniform resource locator (URL) that in one embodiment is provided by the production system.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method of editing a document, comprising:
activating an existing edit hyperlink to access an editable document from a production system;
generating a return reference to redirect a browser back to the production system;
sending the return reference to the editable document web page;
providing access to the return reference at the editable page;
editing the document;
activating the return reference; and
redirecting the browser back to the production system at the location identified by the return reference in response to its activation.

2. The method of claim 1, wherein generating a return reference comprises:
accessing a printing parameter identity service from the production system, the printing parameter identity service containing a plurality of user printing preferences;
encoding the user printing preferences from the printing parameter identity service into the return reference.

3. The method of claim 1, wherein generating a return reference comprises:
generating a link to the production system web application.

4. The method of claim 1, wherein generating a return reference comprises:
generating a link to a preferred production system identity service, the preferred production system identity service containing data on at least one production system.

5. The method of claim 1, and further comprising:
generating a second edit hyperlink to the edited document; and
providing access to the edited document via the second edit hyperlink in the production system.

6. The method of claim 1, wherein generating a return reference comprises generating a return uniform resource locator (URL).

7. The method of claim 1, wherein generating a return reference comprises:
accessing printing parameters from the production system, the printing parameters containing a plurality of user printing preferences; and
encoding the user printing preferences from the printing parameters into the return reference.

8. The method of claim 1, wherein generating a return reference comprises:
generating a link to a preferred production system, the preferred production system containing data on at least one production system.

9. A method of editing a document from a production system, comprising:
calling an existing link to an editable page representing the document;
coding a return uniform resource locator (URL) to the production system;
sending the coded return URL to the editable page;
creating a return hyperlink on the editable page containing the coded return URL;
editing the page; and
activating the return URL when editing is complete.

10. The method of claim 9, wherein coding a return URL comprises:
retrieving a set of printing parameters already selected by a user; and
appending the retrieved set of printing parameters to the return URL.

11. The method of claim 10, wherein retrieving comprises:
accessing a production system parameter bank.

12. The method of claim 10, wherein retrieving comprises:
accessing an identity service containing printing parameter preferences; and
retrieving the set of printing parameters from the identity service.

13. The method of claim 9, and further comprising:
coding an edit URL at the editable page, the edit URL containing a link to an edited version of the document;
sending the edit URL to the production system; and
creating a second edit link on a preview page of the production system, the second edit link containing the edit URL.

14. The method of claim 13, wherein the edit URL comprises first and second URLs, the first URL to the original document and the second URL to the modified document.

15. The method of claim 13, wherein the second edit URL includes a URL to a newly created modified page.

16. The method of claim 13, wherein the edit URL includes a version history with a plurality of URLs, one URL for each saved version of the document.

17. A method of editing a document from a production system, comprising:
generating a production system return reference to the production system upon accessing a preset document edit link on a preview page of the production system;
encoding the return reference information into a command call to a preset document edit link web application;
opening a web application edit page at the document edit link web application for the document;
placing a return hyperlink at the web application edit page, the return hyperlink containing the return reference;
editing the document at the web application edit page; and
returning to the production system when editing is complete.

18. The method of claim 17, wherein returning comprises activating the return hyperlink.

19. The method of claim 17, wherein the web application edit page permanently modifies the original document when editing occurs.

20. The method of claim 19, wherein returning comprises:
generating a second edit link containing a second edit URL for the permanently modified document;
coding the second edit link into a return message to the production system; and
placing the second edit link on a new preview page for the modified document.

21. The method of claim 17, wherein the original document is maintained, and a revised version of the document is created by the web application edit page.

22. The method of claim 21, and further comprising:
generating original and revised version URLs for the original and revised documents; and
returning the original and the revised version URLs to the production system.

23. The method of claim 17, wherein generating a return reference comprises generating a return uniform resource locator (URL).

24. A method of editing a document, comprising:
generating a return reference when a user in a production system preview context clicks an existing edit link;
encoding current printing preferences for the document into the return reference that contains not only the return reference location for the preview page, but also any existing printing parameters that the user has already set at the production system;
directing the user to an edit page with a return reference hyperlink that directs the user back to the production system when editing is complete;
editing the document;
activating the return reference hyperlink to return to the production system;
restoring the printing parameters encoded in the return reference; and
generating a new preview page.

25. A method for editing a document from a production system, comprising:
activating an existing edit link in a document preview page of a production system;
generating a return URL to an identity service that identifies a preferred printing destination for the document;
accessing an identity service that contains information about the currently previewed document;
identifying a source document for the previewed document;
opening the source document in a new or different browser window;
editing the document; and
activating the return URL.

26. A method of generating a return uniform resource locator within a production system, comprising:
activating an existing edit hyperlink to access an editable document from the production system;
generating a return reference to redirect a browser back to the production system;
sending the return reference to the editable document web page;
providing access to the return reference at the editable page;
editing the document;
activating the return reference; and
redirecting the browser back to the production system at the location identified by the return reference in response to its activation.

27. A machine readable medium having a set of machine readable instructions for causing a computer to perform a method comprising:
calling an existing link to an editable page representing a document;
coding a return uniform resource locator (URL) to a production system for producing the document; and
sending the coded return URL to the editable page.

28. The machine readable medium of claim 27, wherein the method further comprises:
creating a return hyperlink on the editable page containing the coded return URL;
editing the page; and
activating the return URL when editing is complete.

29. The machine readable medium of claim 28, wherein the method further comprises:
coding a new edit hyperlink after editing the document, the new edit hyperlink containing a location URL for the edited document; and
sending the coded new edit hyperlink upon activation of the return URL.

30. A machine readable medium having a set of machine readable instructions for causing a computer to perform a method, the method comprising:
activating an existing edit hyperlink to access an editable document from a production system;
generating a return reference to redirect a browser back to the production system; and
sending the return reference to the editable document web page.

31. The machine readable medium of claim 30, wherein the method further comprises:
providing access to the return reference at the editable page;
editing the document;
activating the return reference; and
redirecting the browser back to the production system at the location identified by the return reference in response to its activation.

32. The machine readable medium of claim 30, wherein generating a return reference comprises:
accessing a printing parameter identity service from the production system, the printing parameter identity service containing a plurality of user printing preferences;
encoding the user printing preferences from the printing parameter identity service into the return reference.

33. The machine readable medium of claim 30, wherein generating a return reference comprises:
generating a link to the production system web application.

34. The machine readable medium of claim 30, wherein generating a return reference comprises:
generating a link to a preferred production system identity service, the preferred production system identity service containing data on at least one production system.

35. The machine readable medium of claim 30, wherein the method further comprises:
generating a second edit hyperlink to the edited document; and
providing access to the edited document via the second edit hyperlink in the production system.

36. A machine readable medium having machine readable instructions for causing a computer to perform a method of editing a document from a production system, the method comprising:
generating a production system return uniform resource locator (URL) to the production system upon accessing a preset document edit link on a preview page of the production system;
encoding the return URL information into a command call to a preset document edit link web application;
opening a web application edit page at the document edit link web application for the document;
placing a return hyperlink at the web application edit page, the return hyperlink containing the return URL;
editing the document at the web application edit page; and
returning to the production system when editing is complete.

37. A web application representing a production system, comprising:
a production system driver module; and
a preview command module having machine readable instructions for causing the web application to perform a method comprising:
calling an existing link to an editable page representing the document;
coding a return reference to the production system; and
sending the coded return reference to the editable page.

38. The web application of claim 36, wherein the method further comprises:
creating a return hyperlink on the editable page containing the coded return reference;
editing the page; and
activating the return reference when editing is complete.

39. A web application representing a production system, comprising:
a production system driver module; and
a preview command module, comprising:
means for calling an existing link to an editable page representing the document;
means for coding a return reference to the production system; and
means for sending the coded return reference to the editable page.

40. The web application of claim 39, wherein the preview command module further comprises:
means for creating a return hyperlink on the editable page containing the coded return URL.

41. The web application of claim 39, wherein the preview command module further comprises:
means for coding a new edit hyperlink after editing the document, the new edit hyperlink containing a location URL for the edited document; and
means for sending the coded new edit hyperlink upon activation of the return URL.
